(19) United States
(12) Patent Application Publication
(10) Pub. No.: US 2015/0095898 A1
(43) Pub. Date: Apr. 2, 2015

(54) Method and Apparatus for Tailored Wireless Module Updating

(71) Applicant: Ford Global Technologies, LLC, Dearborn, MI (US)

(72) Inventors: David Mitchell, Dearborn, MI (US); Chad Evert Esselink, Canton, MI (US); Chad Christopher Boes, Plymouth, MI (US); Jeffrey Lee Hentschel, Novi, MI (US); Andrew Shaffer, Bloomfield Village, MI (US)

(73) Assignee: Ford Global Technologies, LLC, Dearborn, MI (US)

(21) Appl. No.: 14/039,235

(22) Filed: Sep. 27, 2013

(51) Int. Cl. G06F 9/445

(52) U.S. Cl. CPC G06F 8/65
USPC 717/168

(57) ABSTRACT

A system includes a processor configured to receive a request from a technician for a software configuration. Further, the processor is configured to send a current software configuration responsive to the request, while maintain verbal communication between the technician and a vehicle occupant. The processor is also configured to receive instructions, relayed from the technician, for installing a software update. Additionally, the processor is configured to process the software update to update the software configuration. The processor is also configured to contact the technician with confirmation of the processed software update upon completion of the update.

### TECHNICAL FIELD

The illustrative embodiments generally relate to a method and apparatus for tailored wireless module updating.

### BACKGROUND

Vehicular software systems are becoming ever increasingly complex. Many vehicles now on the road have numerous software modules associated therewith. Powertrain control, infotainment, navigation and a number of other systems are controlled by hardware and software. Given the complex nature of these systems, and the number of software and hardware components, there are frequently updates that could be useful to vehicle owners. These updates are occasionally difficult to install, and sometimes there are a number of possible updates for a given module. Because computing systems vary from vehicle to vehicle, it may not be clear to a user which update should be selected for a given module.

U.S. Application Publication 2011/307336 generally relates to a method for updating at least one software component of a motor vehicle. The method operates such that the updating of the software component to be updated is offered to the driver by a service facility outside the vehicle before updating is executed. The updating can be enabled solely by the driver of the motor vehicle in response to the offer. The transmission of vehicle configuration information and identification data to the service facility takes place repeatedly in a time controlled and/or event controlled manner without the involvement and/or notification of the driver

U.S. Application Publication 2011/320089 generally relates to a method of updating a vehicle ECU, including establishing communication between a data communications module of a vehicle and an update server via a cellular network; validating the vehicle using a key exchange protocol between the data communications module and the update server; and sending update information from the update server to the data communications module of the vehicle via the cellular network, the update information configured to be used to update the vehicle ECU

U.S. Application Publication 2012/258725 generally relates to over-the-air configuration of a telematics-equipped vehicle by wireless carriers and telematics service providers (TSPs). Regardless of whether a telematics-equipped vehicle has been provisioned for cellular service or not, the TSP and wireless carrier may control undesirable location updating from the vehicle, for example, by setting certain triggers or conditions upon the telematics unit before processing location updates provided by the telematics unit. These triggers or conditions may also be programmed into the telematics unit, whether through an OTA configuration session, or pre-loaded during manufacture. The TSP or wireless carrier may conduct OTA configuration sessions with the telematics unit to provision the telematics unit for cellular service, or provide the telematics unit with software or firmware updates.

### SUMMARY

In a first illustrative embodiment, a system includes a processor configured to receive a request from a technician for a software configuration. Further, the processor is configured to send a current software configuration responsive to the request, while maintain verbal communication between the technician and a vehicle occupant. The processor is also configured to receive instructions, relayed from the technician, for installing a software update. Additionally, the processor is configured to process the software update to update the software configuration. The processor is also configured to contact the technician with confirmation of the processed software update upon completion of the update.

In a second illustrative embodiment, a computer-implemented method includes receiving a request from a technician for a software configuration. The method further includes sending a current software configuration responsive to the request, while maintain verbal communication between the technician and a vehicle occupant. Also, the method includes receiving instructions, relayed from the technician, for installing a software update. The method additionally includes processing the software update to update the software configuration. Further, the method includes contacting the technician with confirmation of the processed software update upon completion of the update.

In a third illustrative embodiment, a non-transitory computer readable storage medium, stores instructions that, when executed by a processor, cause the processor to perform a method that includes receiving a request from a technician for a software configuration. The method further includes sending a current software configuration responsive to the request, while maintain verbal communication between the technician and a vehicle occupant. Also, the method includes receiving instructions, relayed from the technician, for installing a software update. The method additionally includes processing the software update to update the software configuration. Further, the method includes contacting the technician with confirmation of the processed software update upon completion of the update.

### BRIEF DESCRIPTION OF THE DRAWINGS

FIG. 1 shows an illustrative vehicle computing system;

FIGS. 2A-2C show an illustrative system for remote selective updates; and

FIG. 3 shows a process for a wireless selective update.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

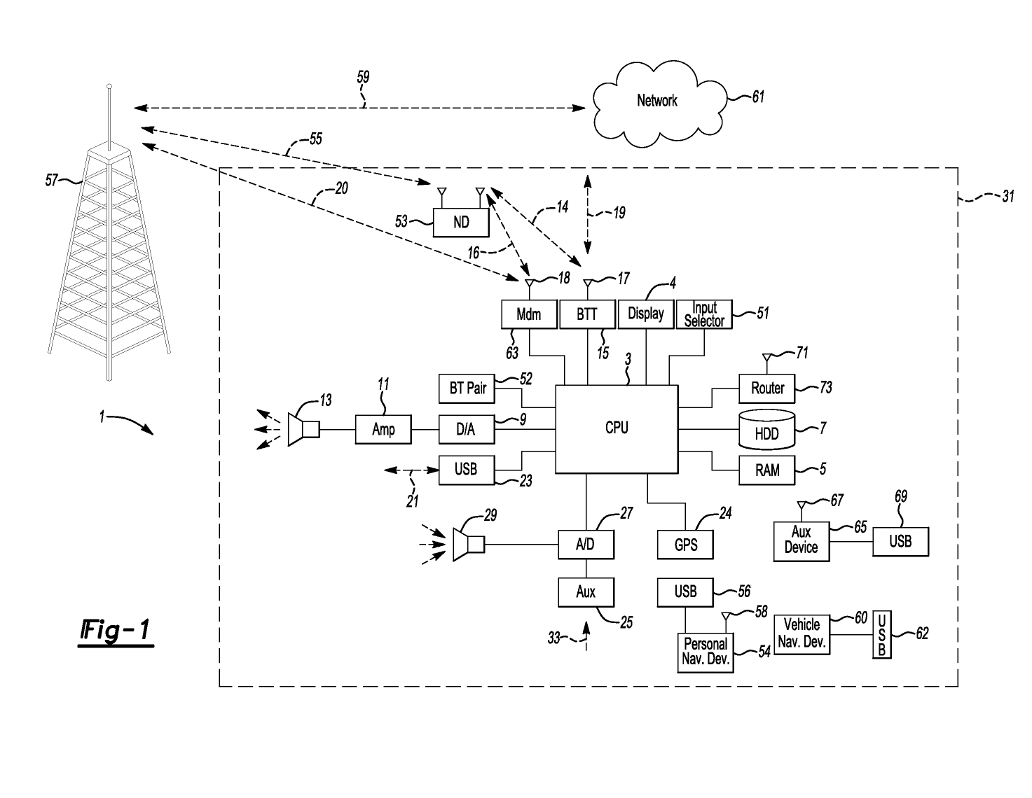

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

When updating vehicle software systems, the number of components and possible updates can be confusing for a novice vehicle owner. Further, later versions of software may be better suited for certain vehicles and not for others. Some features may not be compatible with some vehicles, and other features may simply not work as well with certain vehicles. In order to provide the best driving experience possible, software updates may need to be carefully selected with both a vehicle and a driver's needs in mind.

The illustrative embodiments relate to operator assisted software updates. A remote operator can upload a vehicle configuration, examine the configuration and discuss a driver's needs, and then select software that will best suit the driver and vehicle. Since the remote operator will likely have a good deal more information about various software and system updates than a driver will, the remote operator may be in a better position to recommend particular updates or system upgrades.

Also, if there are any error messages that currently exist or occur during the update process, a skilled technician may be better suited to examine the errors and come up with acceptable work-arounds or alternatives. This gives the driver the peace of mind, knowing that an OEM certified technician is selecting and installing a proper set of system updates.

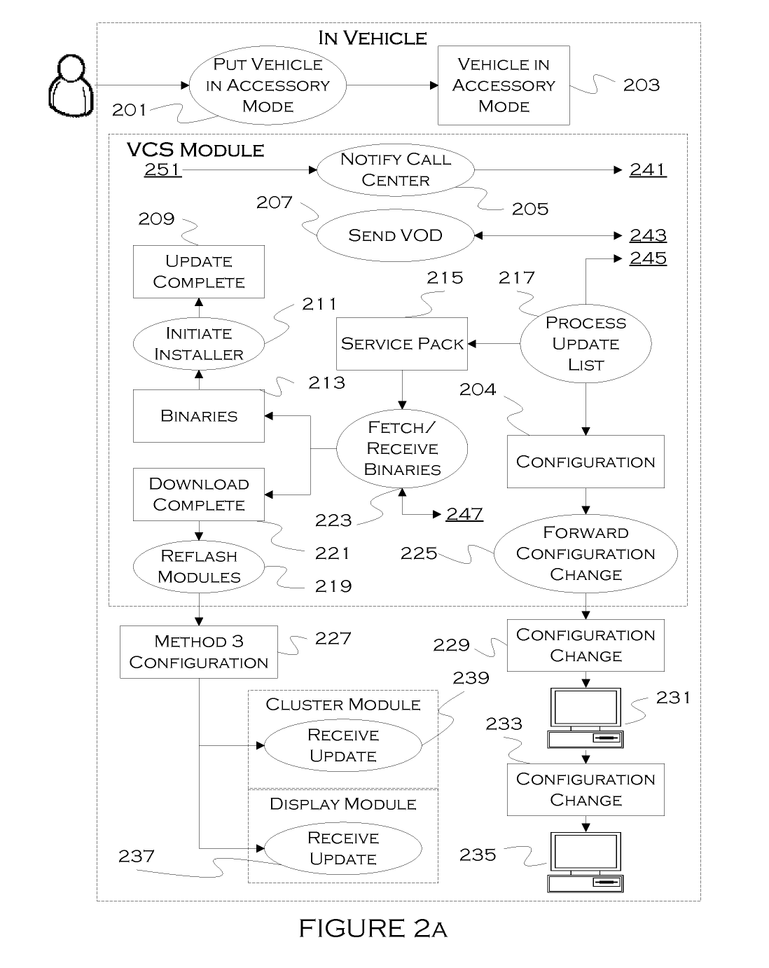

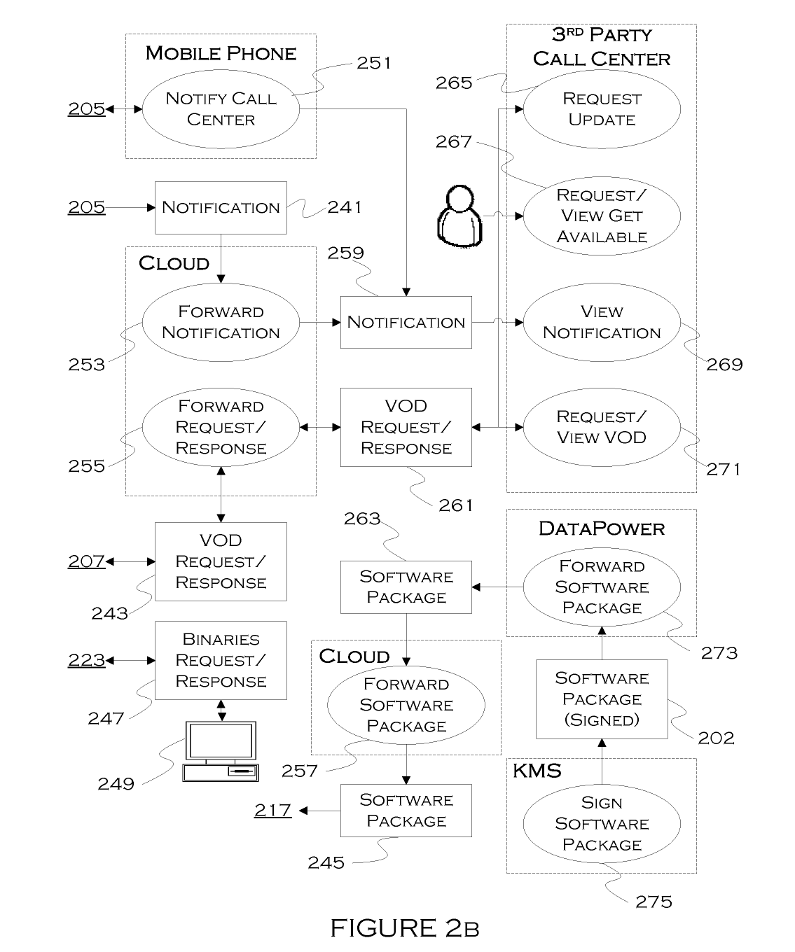

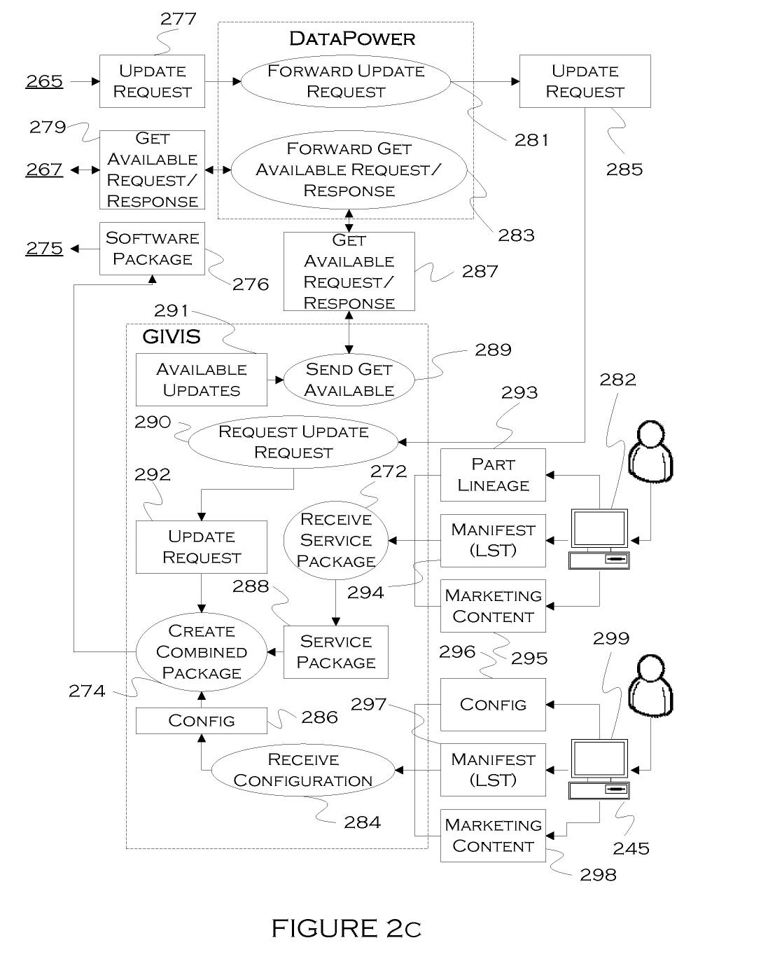

FIGS. 2A-2C show an illustrative system for remote selective updates. FIG. 2A shows an in-vehicle portion of the illustrative process. In this illustrative portion of the system the in vehicle component has a number of modules provided thereto, including the VCS module, a cluster module, a display module, and several hardware components. These are illustrative and are not representative of the entire system. FIG. 2B shows a portion of the system including a mobile phone, a cloud router, a call center, and several data control points. FIG. 2C shows a back-end OEM data provision service, which can provide various updates for inclusion to a user's system.

When the user wants to utilize remote assistance for selecting software upgrades, the user uses the VCS module to place a call to a call center 205. This places the user in touch with a remote technician, who can assist in upgrading various software and firmware modules provided to the vehicle. The call center tech may ask the user to place the vehicle into an accessory mode 201, which allows the tech to access and edit various features of the vehicle computing system and other modules.

The call to the call center can be sent as a notification through a mobile phone 251. Also, the VCS module may notify the call center 205, sending a notification 241 through a cloud server 253. The notifications may be combined to provide a notification to a call center tech for viewing 269. The call center tech may also want to view a current configuration of the software modules and other firmware on the vehicle computing system. The tech can place a request to view the VOD 271, which represents the current configurations and versions of the software installed on the vehicle.

The VOD configuration request 261 is passed through the cloud routing server 255. The request 243 is then sent back to the vehicle computing system for fulfillment. The vehicle computing system will then send a VOD report 207 back to the tech, so the tech has a list of the software and firmware installed on the vehicle.

While the software request is processing, the tech can communicate with the vehicle occupant to discuss needs for software updates. The occupant can describe commonly used features, common vehicle tasks and any other information relevant to possible updates. The tech can generally describe possible features that might be helpful for the driver once the system modules have been examined for compatibility.

Once the modules are available for viewing by the tech, the tech can send a “get available” request 267 to the remote back-end OEM database. This request is similar to one that could be sent by a user to find out all available updates that are compatible with a given configuration. The get available request 279 is forwarded 283 to a GIVIS system. Once the GIVIS system, which stores the updates and configuration possibilities for vehicles, receives the request for available updates 287, it can send a request to an internal data store 289 which will produce available updates. These updates can then be responsively passed back to the requesting technician, so the technician can view the possible updates for the requesting vehicle.

At this point, the technician can see all possible updates for the vehicle, as well as the existing vehicle configuration. This will allow the tech, through communication with the customer, to establish which, if any, updates should be uploaded to the current system for install.

Once the tech and the customer have agreed on a strategy for installing updates, the tech can then send a request to the OEM system for supplying updates to the vehicle and instructing their installation 265. The update request 277 is forwarded to the GIVIS system as well. Once the GIVIS system receives 290 the update request 285, the system can pass along the update request 292 for creation of a combined package. The combined package will contain all of the information that is needed for passing along to the vehicle information system for update of the software modules.

On the back-end, software and systems engineers can use IVS systems 282, 299 to create service packages and configurations for uploading to vehicles. Each of the various engineered data elements can contain, for example, a part lineage 293, 296, a manifest 294, 297, and any marketing content desired 296, 298. This information can be used to identify opportunities for upgrades based on various received vehicle configurations. This information can also be used by the vehicle to verify that an update is appropriate for the given vehicle.

The GIVIS receives the service packages 272 and receives the configurations 284. The service packages 288 and configurations 284 can then be used to create the combined package 274. The created combined software package 276 can then be sent for digital signature. Once the package has been signed 275, it can be passed along for forwarding to the vehicle computing system.

The package is forwarded 273 to the cloud based routing services, where the package 263 is forwarded again to the vehicle system. Again, this particular chain is for exemplary illustrative purposes only, and is not intended to limit the invention in any manner.

The package 245 is received at the VCS, which can then process an update list based on the package 217. At this point, the customer has communicated their needs to the technician, the tech has selected and requested the relevant software updates, and the updates have been uploaded to the customer vehicle for installation.

From the received software package, the VCS can extract the service pack for this update 215 and a configuration. Then configuration details a new configuration for the vehicle software and hardware. The process forwards a configuration change (i.e., the new configuration) 225, to a BCM 235. The configuration change 229, 233 is passed along a CAN bus 231.

The service pack is unpacked and contains the actual updates for the various software and firmware modules. The service pack data 215 is used for installation purposes, at a time when it is appropriate. For example, it may not be appropriate for the data update to occur immediately. Since critical or even merely useful system data may be affected by the update, any errors or lapses in usability could present difficulties for a driver. Accordingly, the process may wait until the vehicle is in a parked state before applying any updates.

Since this could take some time, the service tech may disconnect. The tech may then reconnect after the attempted installation to ensure the installation went smoothly. The service pack software is passed to a request for binaries 223, which is passed to an external system 249. The request and responsive binaries 247 are relayed between the system and the vehicle computing system.

The binaries 213 are used to initiate an installer 211, which process the update until the update is complete 209. Once the installation and download of all appropriate modules is completed 221, the process can refresh the modules 219 to ensure that the newly updated modules are functioning correctly. If updates are provided for the cluster modules, display modules or any other modules, the reconfiguration and update of these modules 227 can be processed so that the various modules receive their respective updates 237, 239.

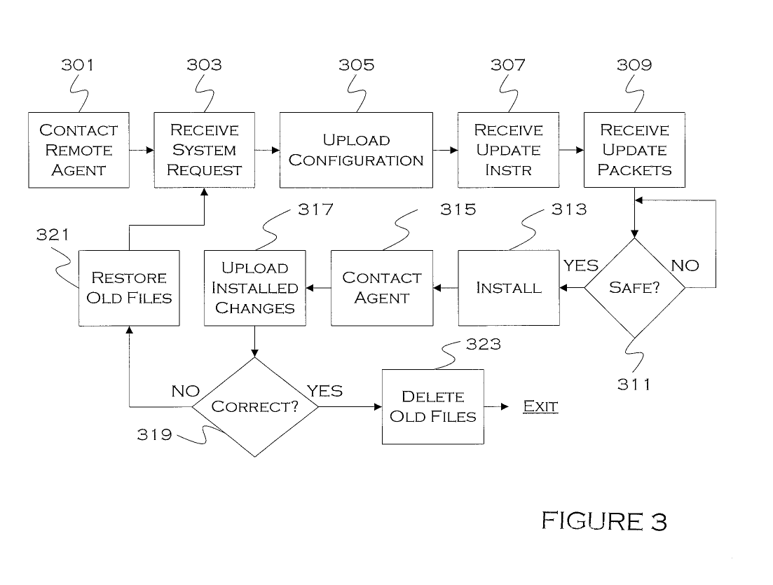

FIG. 3 shows a process for a wireless selective update. This is a process flow that shows an exemplary, non-limiting example of an illustrative process for updating according to the illustrative embodiments. This illustrative process runs locally on the vehicle, in this example. In this example, the process starts by contacting the remote agent 301. The remote agent is a technician or other party qualified to provide update advice and configuration information for the requesting user's vehicle.

After the technician and the customer connect, the technician may wish to pull a configuration of the vehicle system. In doing so, the technician may send a request for the current vehicle configuration. Once the process receives the system request 303, the process may gather the current configuration. This can be for all vehicle modules, or for specific requested modules. The gathered configuration is then uploaded to the requesting system 305.

At this point, as was seen in the system, the technician and the customer can have a discussion to select the appropriate updates for the system. The technician can the select the appropriate updates and instruct that they be uploaded to the system. Once instructed, the process may receive various information from the remote server.

The process receives update instructions 307 and some number of update data packets 309 that relate to the updates to be installed. Data download can be ongoing while the vehicle travels, as it should not interfere with the vehicle systems. Installation of the data, however, may not occur until a point where the vehicle is in a safe state, such as park 311. Running on limited power, the system could even perform updates while the vehicle is otherwise turned off.

Once the vehicle is in a safe state, the process begins installation 313. At the completion of the installation process (or the next convenient time when communication capabilities are present), the process may contact the installation agent or agency 315. The results of the update may be uploaded to the agent 317.

Any errors or improper updates can be processed at this time. The agent gets a list of the errors and any other issues with the installation. The agent can also confirm, at this time, if the update is completed with no problems or changes. If the agent decides the update was correct (or if there were no apparent errors, in another embodiment) 319, the process can delete old versions of files stored for restoration purposes 323. On the other hand, if there were one or more errors or other changes that need to be made, any old files that need to be restored can be done so from the backups 321. At this point, the agent can again go through the process of selecting and confirming appropriate update installation.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A system comprising:
a processor configured to:
receive a request from a technician for a software configuration;
send a current software configuration responsive to the request, while maintaining verbal communication between the technician and a vehicle occupant;
receive instructions, relayed from the technician, for installing a software update;
process the software update to update the software configuration; and
output confirmation of the processed software update upon completion of the update to the technician.

2. The system of claim 1, wherein the software configuration includes a firmware configuration.

3. The system of claim 2, wherein the software update includes a firmware update.

4. The system of claim 1, wherein the confirmation includes a list of any errors encountered while processing the update.

5. The system of claim 1, wherein the confirmation includes a new software configuration reflecting updated software modules.

6. The system of claim 1, wherein the processor is configured to queue contact with the technician until such a communication channel is available.

7. The system of claim 1, wherein the processor is configured to wait until a vehicle is in a parked state before processing the software update.

8. A computer-implemented method comprising:
receiving a request from a technician for a software configuration;
sending a current software configuration responsive to the request, while maintain verbal communication between the technician and a vehicle occupant;
receiving instructions, relayed from the technician, for installing a software update;
processing the software update to update the software configuration; and
outputting confirmation of the processed software update upon completion of the update to the technician.

9. The method of claim 8, wherein the software configuration includes a firmware configuration.

10. The method of claim 9, wherein the software update includes a firmware update.

11. The method of claim 8, wherein the confirmation includes a list of any errors encountered while processing the update.

12. The method of claim 8, wherein the confirmation includes a new software configuration reflecting updated software modules.

13. The method of claim 8, further comprising queuing contact with the technician until such a communication channel is available.

14. The method of claim 8, wherein the processing includes waiting until a vehicle is in a parked state before processing the software update.

15. A non-transitory computer readable storage medium, storing instructions that, when executed by a processor, cause the processor to perform a method comprising:
receiving a request from a technician for a software configuration;
sending a current software configuration responsive to the request, while maintain verbal communication between the technician and a vehicle occupant;
receiving instructions, relayed from the technician, for installing a software update;
processing the software update to update the software configuration; and
outputting confirmation of the processed software update upon completion of the update to the technician.

16. The storage medium of claim 15, wherein the software configuration includes a firmware configuration.

17. The storage medium of claim 16, wherein the software update includes a firmware update.

18. The storage medium of claim 15, wherein the confirmation includes a list of any errors encountered while processing the update.

19. The storage medium of claim 15, wherein the confirmation includes a new software configuration reflecting updated software modules.

20. The storage medium of claim 15, wherein the processing includes waiting until a vehicle is in a parked state before processing the software update.
